(19) United States
(12) Patent Application Publication
(10) Pub. No.: US 2008/0162653 A1
(43) Pub. Date: Jul. 3, 2008

(54) APPARATUS AND METHOD FOR BLOCKING EMAIL RECEIPT RESPONSE

(75) Inventor: Geun-sik LIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/832,151

(22) Filed: Aug. 1, 2007

(30) Foreign Application Priority Data
Dec. 28, 2006 (KR) 2006-136764

(51) Int. Cl. G06F 15/16

(52) U.S. Cl. 709/206

(57) ABSTRACT

An apparatus to block an email receipt response includes a reading unit to read tag information of an email and a forging unit to perform a forging process on a predetermined information item of the read tag information.

### CROSS-REFERENCE TO RELATED APPLICATION

This application claims the benefit of Korean Application No. 2006-136764 filed in the Korean Intellectual Property Office on Dec. 28, 2006, the disclosure of which is incorporated herein by reference.

### BACKGROUND OF THE INVENTION

1. Field of the Invention

Aspects of the present invention relate to an apparatus and method for blocking an email receipt response. In particular, aspects of the present invention relate to an apparatus and method for blocking an email receipt response that forges tag information of an email to block transmission of a receipt response packet to the email sender, thereby protecting the user's privacy and preventing a function of responding to a received email from being misused.

2. Description of the Related Art

Recently, with development of communication networks like the Internet, interchange of information among users using email services has been encouraged. A sender accesses the Internet by means of a cellular phone, a PC, an internet TV, a PDA, a PMP, etc., composes an email, and sends the email to a receiver. The receiver opens the email sent by the sender. If the sender sets up a receipt response function on the email to be sent, the sender can see whether the receiver has opened the email. The email receipt response function will be described with reference to FIG. 1.

FIG. 1 is a conceptual view illustrating an email receipt response function according to the related art. First, a sender accesses the Internet by means of an apparatus capable of accessing the Internet, composes an email, and sends the email to a receiver (operation S11). The receiver receives the email by means of an apparatus capable of accessing the Internet (operation S21). If the receiver opens the email, a receipt response packet including information on the time when the receiver opens the email (receipt response date and time) is transmitted to a mail server of the sender (operation S31). Therefore, the sender can see whether the receiver has read the email by checking the email receipt response time information of the receiver.

Since the sender can see whether the receiver checks the email, a person's privacy can be invaded and the receipt response function can be misused.

### SUMMARY OF THE INVENTION

Aspects of the present invention provide an apparatus and method for blocking an email receipt response that can protect a user's privacy and prevent an email receipt function from being misused.

According to an aspect of the present invention, an apparatus to block an email receipt response is provided. The apparatus includes a reading unit to read tag information of an email sent by a sender to a recipient; and a forging unit performing a forging process on a predetermined information item of the read tag information. The forging unit may perform the forging process so as to prevent transmission of a receipt response packet to the sender.

According to another aspect of the present invention, a method for blocking an email receipt response is provided. The method includes reading tag information of an email; and performing a forging process on a predetermined information item of the read tag information so as to block the transmission of a receipt response packet.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual view of an email receipt response function;

FIG. 2 is a block diagram illustrating an apparatus for blocking an email receipt response according to an embodiment of the invention;

FIG. 3 is a conceptual view of a method of blocking an email receipt response according to an embodiment of the invention;

FIG. 4 is a diagram illustrating formats of tag information in a message header of an email according to an embodiment of the invention;

FIG. 5 is a diagram illustrating information on received emails according to an embodiment of the invention;

FIG. 6 is a diagram illustrating a screen for setting a function of blocking transmission of a receipt response packet according to an embodiment of the invention; and

FIG. 7 is a flow chart illustrating a method of blocking an email receipt response according to an embodiment of the invention.

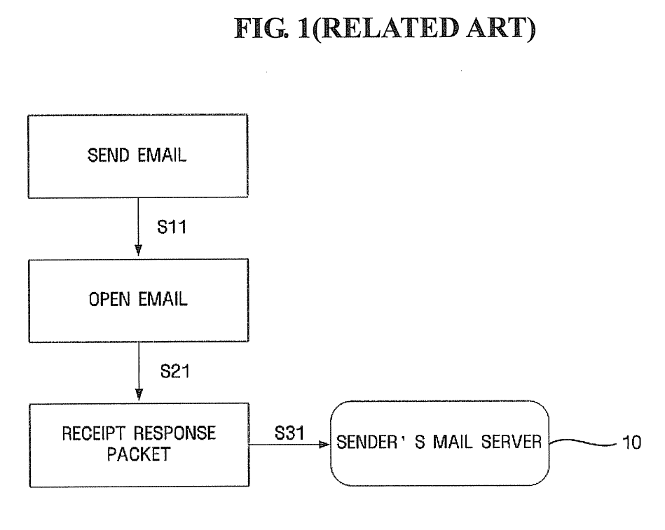

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

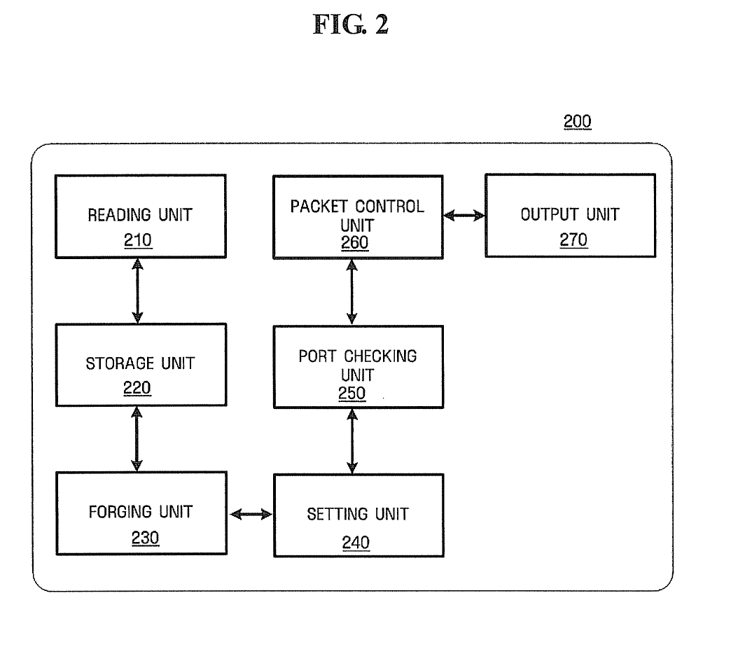

FIG. 2 is a block diagram illustrating an apparatus for blocking an email receipt response according to an embodiment of the invention. An apparatus 200 for blocking an email receipt response includes a reading unit 210, a storage unit 220, a forging unit 230, a setting unit 240, a port checking unit 250, a packet control unit 260, and an output unit 270. The apparatus 200 for blocking an email receipt response may be realized in a mail server of a receiver, may be a computer having a connection to the Internet, may be a portable device such as a mobile phone or personal digital assistant having email capability, or may be located in another device or a separate device in a network. The apparatus 200 according to other aspects of the invention may include additional components, such as a receiving unit to receive the email from the sender.

The reading unit 210 reads tag information of a received email. The tag information may include, for example, the unique ID, email address, mail server, and communication port of a sender who has sent the email, and information on the email message. The storage unit 220 stores the tag information of the read email. The storage unit 220 may store the tag information in a table format of a database. For example, the storage unit may store the email address of the sender, the arrival time of the email, the message information of the email, or other information about the sender and the email. The stored information can be output on a screen of the receiver's apparatus through the output unit 270.

The forging unit 230 forges a predetermined information item of the read tag information. For example, the forging unit 230 may change a predetermined information item of the read tag information or may delete the predetermined information item from the read tag information. Therefore, the forging unit 230 can prevent a receipt response packet from being transmitted to the sender when the receiver opens the email. The forging unit 230 may maintain the message information of the email and forge only an item of the tag information required to block a route through which the receipt response packet is transmitted to the sender, may delete the message information, or may forge any item of the tag information.

In the past, when a receiver opened an email, a receipt response packet was transmitted to a mail server of a sender through the unique ID or email address of the sender included in tag information of a message header. For this reason, the predetermined information item of the tag information of the received email is changed or deleted so as to prevent the receipt response packet from being transmitted to the mail server of the sender. For example, the forging unit 230 may delete, from the tag information, information on the unique ID and email address of the sender so as to prevent the receipt response packet from being transmitted to the mail server of the sender. The receipt response packet may include information on the receiver's system, the receipt response date and time for the email, or other information. “Or” is used herein in an inclusive sense; thus, for example, the receipt response packet may include information on the receiver's system, the receipt response date and time, or both the information and the receipt response data and time.

The setting unit 240 provides a set menu on the screen of the receiver's apparatus to enable the receiver to set whether to block the transmission of the receipt response packet. The receiver can set or release the function of blocking the transmission of the receipt response packet through the set menu. For example, if the function of blocking the transmission of the receipt response packet is set, the forging unit 230 forges or deletes the predetermined information item of the tag information of the email on the basis of the set function so as to prevent transmission of the receipt response packet to the sender. In contrast, when the function of blocking the transmission of the receipt response packet is released, the receipt response packet is transmitted to the sender if the receiver opens the email.

The port checking unit 250 checks whether a predetermined packet is transmitted through a communication port other than a designated communication port. For example, if a communication port 4280 is designated for transmission of the packet, the port checking unit 250 checks whether the packet is transmitted through a communication port other than the communication port 4280. The port checking unit 250 may be used, together with the forging unit 230, to block the transmission of the receipt response packet or may be used to drop, through the packet control unit 260, packets transmitted through a communication port other than the communication designated by a separate function, so as to prevent information about the receiver's system from leaking out.

When a predetermined packet is transmitted through a communication port other than the communication port designated through the port checking unit 250, the packet control unit 260 drops the corresponding packet. If a predetermined packet is transmitted through a communication port other than the designated communication port, the packet control unit 260 drops the corresponding packet so as to prevent the information on the receiver's system from leaking out or being used for receipt response. The port checking unit 250 and the packet control unit 260 may be omitted in other aspects of the present invention.

The output unit 270 outputs the tag information stored in the storage unit 220 on a screen (not shown) of the receiver's apparatus. The receiver can check the message information of the email sent by the sender and a variety of information on the sender side stored in the storage unit 220. Since the function of blocking the transmission of the receipt response packet to the sender has been set through the forging unit 230, the receiver can safely check the email.

Each of the components shown in FIG. 2 may be composed of one or more modules. The term “module” refers to software or a hardware component such as an FPGA (field programmable gate array) or an ASIC (application specific integrated circuit). A module has a specific function. However, a module is not limited to software or hardware. A module can be made in an addressable storage medium and can be made to reproduce at least one processor. For example, a module includes components such as software components, object-oriented software components, class components, and task components, processors, functions, attributes, procedures, sub-routines, segments of program code, drivers, firmware, microcode, circuits, data, databases, data structures, tables, arrays, and variables. Functions provided in the components and the modules can be combined so as to be realized by a smaller number of components and modules or can be divided so as to be realized by additional components and modules.

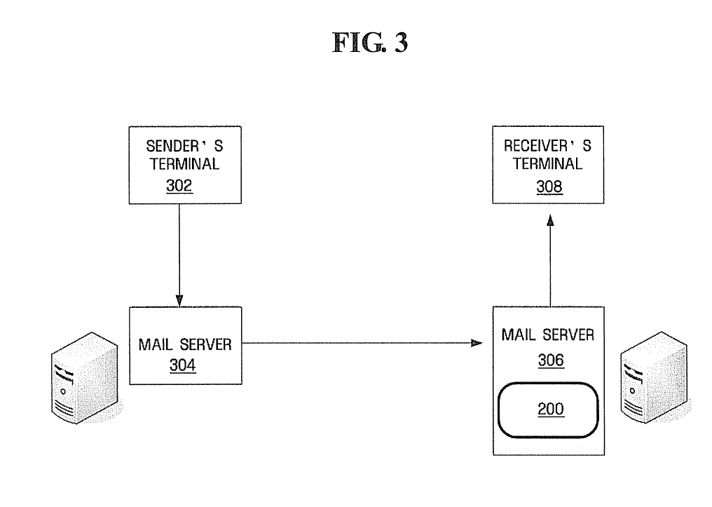

FIG. 3 is a conceptual view of a method of blocking an email receipt response according to an embodiment of the invention. For example, if the sender composes the email using a sender's terminal 302 and sends the email to the receiver, a mail server 304 of the sender transmits the composed email to a mail server 306 of the receiver through a wired and/or wireless network. While not required in all aspects, the apparatus 200 may be included in the mail server 306. The mail server 306 is not a limiting feature of the present invention; other aspects of the present invention may receive the email in any fashion, with the apparatus 200 being installed locally on the terminal 308 or at a separate server. Similarly, the email message may be any message with a receipt response feature, such as email or SMS.

When the apparatus 200 for blocking an email receipt response according to the embodiment of the invention is realized in the mail server 306, the reading unit 210 reads the tag information of the received email and stores the read tag information of the email in the storage unit 220 of the apparatus 200. If the function of blocking the transmission of the receipt response packet is set by the setting unit 240, the forging unit 230 forges or deletes the predetermined information item of the read tag information so as to prevent the receipt response packet from being transmitted to the sender.

The receiver can open and check the email sent by the sender through a receiver's terminal 308 before or after the apparatus 200 has blocked the receipt response packet. The receiver can check the message information of the email sent by the sender and a variety of information on the sender side stored in the storage unit 220. Further, since the function of blocking the transmission of the receipt response packet to the sender has been set, the receiver can safely check the email.

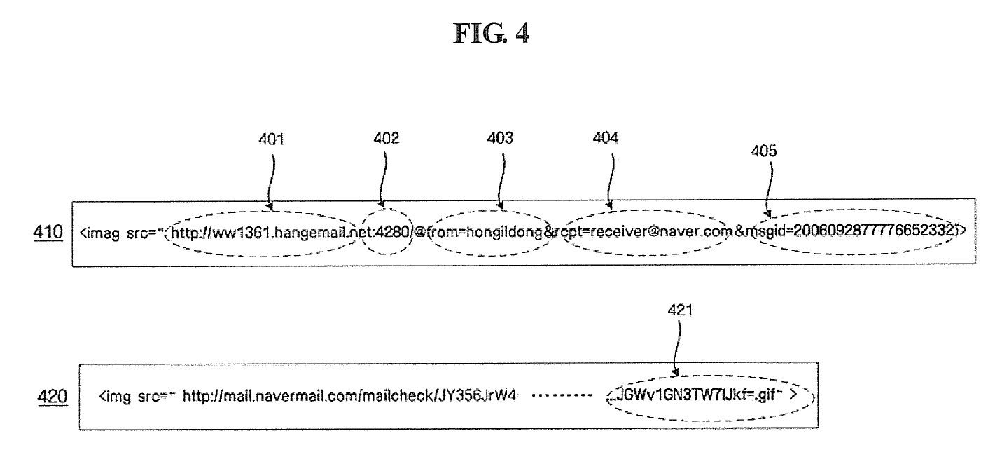

FIG. 4 is a diagram illustrating formats of tag information in a message header of an email according to an embodiment of the invention. The apparatus 200 forges or deletes a predetermined information item of tag information of an email so as to block the transmission of a receipt response packet to the sender.

As shown in FIG. 4, the tag information in the message header can be configured into various formats. The first format 410 shows the tag information, including sender's mail server information 401, communication port information 402, sender's nickname information 403, receiver's mail address information 404, and sender's unique ID information 405. The reading unit 210 reads the tag information in the message header and stores the read tag information in the storage unit 220. The forging unit 230 forges or deletes the predetermined information item of the read tag information so as to prevent the receipt response packet from being transmitted to the sender.

By way of example, for the first format 400, the receipt response packet can be transmitted through the sender's mail server information 401 and unique ID information 405. For this reason, the forging unit 230 may delete or forge the sender's unique ID information 405 so as to block the transmission of the receipt response packet to the sender.

The port checking unit 250 checks whether the predetermined packet is transmitted through a communication port other than the designated communication port. If information related to the communication port is included in the predetermined packet, the port checking unit 250 can check whether the predetermined packet is transmitted through a communication port other than the designated communication port. In the shown example, since the communication port 4290 is designated for transmitting the packet, the corresponding packet is dropped, since the communication port information 402 included in the first format 410 of the message header indicates that the communication port 4280 is used.

Similarly, the second format 420 of the message header shows tag information including sender's unique ID information 421. As such, the forging unit 230 may alter or delete the unique ID information 421 to prevent the transmission of the return receipt message.

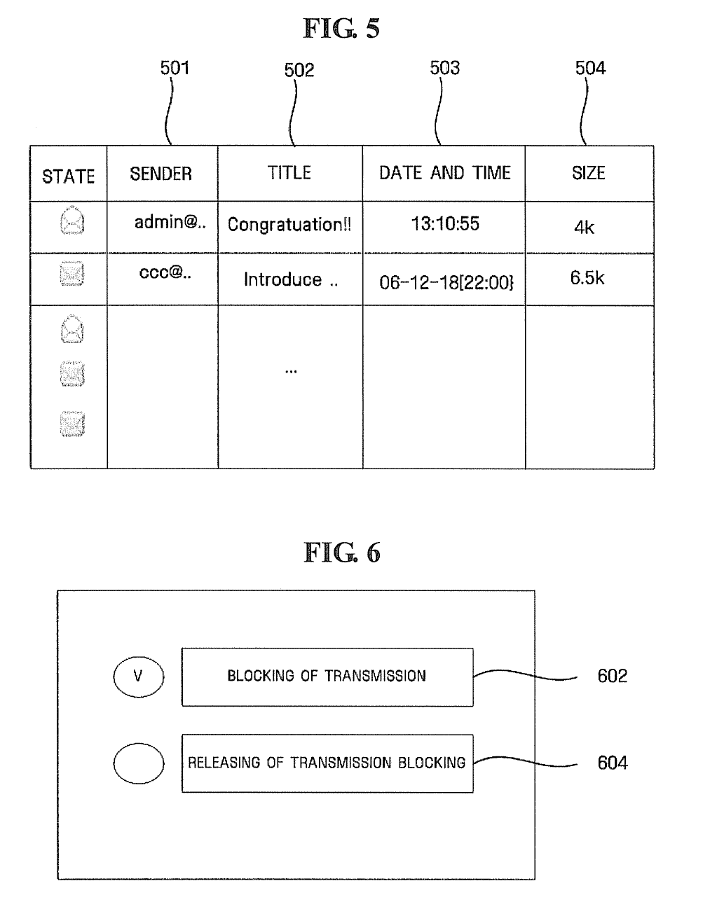

FIG. 5 is a diagram illustrating information on received emails according to an embodiment of the invention. Information on received emails may be supplied on the screen of the receiver's apparatus 308, but can be otherwise provided. For example, through the tag information read by the reading unit 210, the receiver is supplied with sender's email address information 501, message title information 502, email transmission date and time information 503, email size information 504, etc. The information supplied on the screen is the information stored in the storage unit 220 (i.e., the information from which the tag information has not been forged or deleted.) The receiver can check the sender of each email and the information on the sender's system. Further, even if the receiver clicks on a message title 502 of an email so as to open the email, since the function of blocking the transmission of the receipt response packet to the sender is set by the forging unit 230, the privacy and system information of the receiver is safely protected.

FIG. 6 is a diagram illustrating a screen for setting a function of blocking transmission of a receipt response packet according to an embodiment of the invention. The receiver can set whether to block the transmission of the receipt response packet on the screen of the apparatus. For example, if “blocking of transmission” 602 is set, the forging unit 230 forges or deletes the predetermined information item of the tag information of the email on the basis of the set contents so as to prevent the receipt response packet from being transmitted to the sender. In contrast, when “releasing of the transmission blocking” 604 is set, if the receiver opens the email, the receipt response packet is transmitted to the sender.

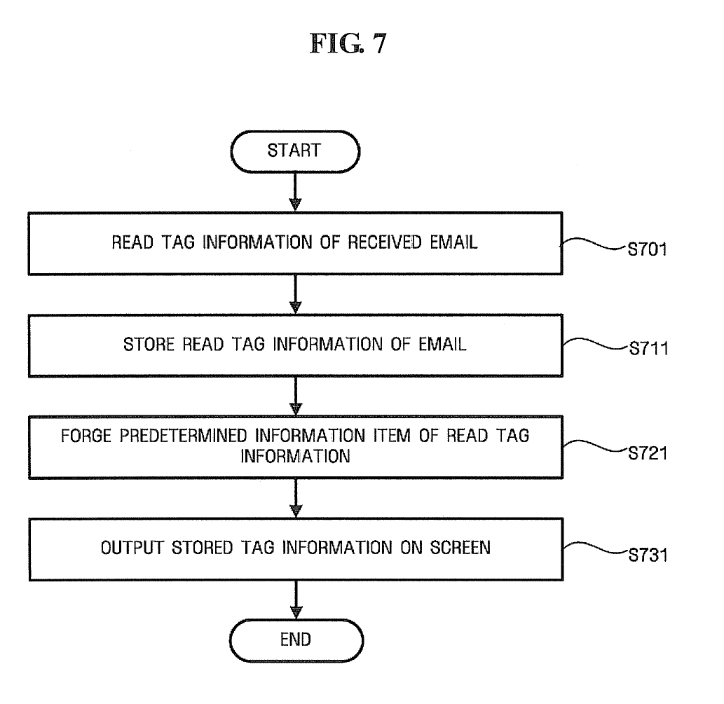

FIG. 7 is a flow chart illustrating a technique of blocking an email receipt response according to an embodiment of the invention. First, the reading unit 210 reads the tag information of the received email (operation S701). The tag information may include information on the unique ID, email address, mail server, and communication port of the sender of the email and the email message. The storage unit 220 stores the read tag information of the email (operation S711).

The forging unit 230 forges the predetermined information item of the read tag information so as to prevent the transmission of the receipt response packet to the sender of the email (operation S721). The output unit 270 outputs the tag information stored in the storage unit 220 on the screen of the receiver's apparatus (operation S731). The receiver can check the message information of the email sent by the sender and a variety of information on the sender side. Further, since the function of blocking the transmission of the receipt response packet to the sender has been set through the forging unit 230, the receiver can safely check the email.

If a port is designated for transmission of the packet to the outside, the port checking unit 250 checks whether the predetermined packet is transmitted through a communication other than the designated port.

Privacy protection techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

As described above, according to the apparatus and method for blocking an email receipt response according to aspects of the present invention, it is possible to protect a user's privacy and to prevent the email receipt response function from being misused.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to block an email receipt response, the apparatus comprising:
a reading unit to read tag information of an email sent by a sender to a recipient; and
a forging unit to perform a forging process on a predetermined information item of the read tag information so as to change or delete the predetermined information item in the tag information.

2. The apparatus of claim 1, wherein the forging unit performs the forging process to prevent a receipt response packet including information on whether the email is received from being transmitted to the sender.

3. The apparatus of claim 2, further comprising:
a port checking unit to check whether the receipt response packet is transmitted through a communication port other than a designated communication port.

4. The apparatus of claim 3, further comprising:
a packet control unit to drop the receipt response packet when the receipt response packet is transmitted through the communication port other than the designated communication port.

5. The apparatus of claim 2, further comprising:
a setting unit to provide, on a display, a set menu enabling a user to set whether to block transmission of the receipt response packet.

6. The apparatus of claim 1, further comprising:
an output unit to output the read tag information on a display of a user.

7. The apparatus of claim 1, wherein the forging unit performs a forging process on the tag information of a message header of the email.

8. The apparatus of claim 1, wherein the tag information comprises information items on the unique ID, email address, and/or mail server of the sender.

9. A method of blocking an email receipt response, the method comprising:
reading tag information of an email; and
performing a forging process on a predetermined information item of the read tag information to change or delete the predetermined information item so as to block the transmission of an email receipt response packet.

10. The method of claim 9, wherein the performing of the forging process comprises preventing transmission, to a sender of the email, of a receipt response packet including information on whether the email is received due to the changed information item.

11. The method of claim 10, further comprising:
checking whether the receipt response packet is transmitted through a communication port other than a designated communication port.

12. The method of claim 11, further comprising:
dropping the receipt response packet when the receipt response packet is transmitted through the communication port other than the designated communication port.

13. The method of claim 9, further comprising:
providing, on a display, a set menu enabling the user to set whether to block transmission of the receipt response packet.

14. The method of claim 9, further comprising:
outputting the read tag information on an apparatus of a user.

15. The method of claim 9, wherein, in the performing of the forging process, the forging process is performed on the tag information of a message header of the email.

16. The method of claim 9, wherein the tag information comprises information items on the unique ID, email address, and/or mail server of a sender.

17. The apparatus of claim 1, further comprising:
a storage unit to store the tag information read by the reading unit;
wherein the stored tag information is recalled to display information on the sender when the receiver accesses the email.

18. An apparatus to protect the privacy of a message recipient, the apparatus comprising:
a receiving unit to receive a message sent by a sender to a receiver; and
a forging unit to forge a predetermined item of tag information in the message in a way that prevents the transmission of a receipt response packet to the sender.

19. The apparatus of claim 18, further comprising:
a reading unit to read the tag information from the message.

20. The apparatus of claim 18, further comprising:
a storage unit to store the tag information;
wherein the forging unit uses the tag information stored in the storage unit to forge the tag information.

21. The apparatus of claim 18, wherein the tag information comprises a unique ID of the sender, an address of the sender, and/or a mail server of the sender.

22. A computer readable medium comprising instructions that, when executed by a computer, cause the computer to perform a method of protecting the privacy of a message recipient, the method comprising:
receiving a message sent by a sender to a receiver;
changing a predetermined item of tag information included in the message that is needed to send a receipt response packet to the sender so as to prevent transmission of a receipt response packet to the sender.
